(19) United States
(12) Patent Application Publication
(10) Pub. No.: US 2025/0080211 A1
(43) Pub. Date: Mar. 6, 2025

(54) ANTENNA STRUCTURE AND LOW EARTH ORBIT SATELLITE SYSTEM

(71) Applicant: QuantumZ Inc., Kaohsiung City (TW)

(72) Inventors: Kun Yen TU, Kaohsiung City (TW); Meng-Hua TSAI, Kaohsiung City (TW); Sin-Siang WANG, Kaohsiung City (TW); Wei Ting LEE, Kaohsiung City (TW); Ming-Hsiang HUANG, Kaohsiung City (TW)

(21) Appl. No.: 18/749,578

(22) Filed: Jun. 20, 2024

(30) Foreign Application Priority Data
Aug. 30, 2023 (TW) 112132870

(51) Int. Cl. H04B 7/185; H01Q 1/48; H01Q 1/50; H01Q 9/04; H01Q 23/00

(52) U.S. Cl. CPC H04B 7/18515; H01Q 1/48; H01Q 1/50; H01Q 9/0414; H01Q 23/00

(57) ABSTRACT

An antenna structure includes an upper patch antenna, a lower patch antenna, a grounding layer, a transmission line layer, and a first feeding line and a second feeding line passing through the grounding layer. Each of the first feeding line and the second feeding line includes a first portion, a second portion and a third portion. The first portion is disposed between the lower patch antenna and the grounding layer and is perpendicular to the grounding layer. The second portion is disposed between the grounding layer and the transmission line layer and is perpendicular to the grounding layer. The third portion is disposed within the grounding layer and is parallel to the grounding layer. The third portion is coupled between the first portion and the second portion.

### CROSS-REFERENCE TO RELATED APPLICATION

This application claims priority to Taiwan Application Serial Number 112132870, filed Aug. 30, 2023, which is herein incorporated by reference in its entirety.

### BACKGROUND

### Field of Invention

The present disclosure relates to an antenna structure, particularly to an antenna structure and a low earth orbit satellite system.

### Description of Related Art

Beamforming technology is required for low orbit satellite communications. For example, four antennas are required when using one beamforming IC. A small base station of the low orbit satellite requires at least 256 beamforming ICs, which require 1024 antennas. In addition, two sets of antennas are respectively used for uploading and downloading, and thus 2048 antennas are required. Therefore, such small base station for low orbit satellite is designed to be vehicle-mounted. The small base station is placed on the roof of the vehicle for use in remote areas where tower signals often do not cover. Such vehicle-mounted products are affected by weather conditions such as rain, temperature and clouds. In addition, 256 beamforming ICs require a multi-order power divider, and thus it is also an issue that requires efforts in current low orbit satellite communications about how to reduce line losses.

### SUMMARY

The present disclosure provides an antenna structure including an upper patch antenna, a lower patch antenna, a grounding layer, a transmission line layer, a first feeding line and a second feeding line. The lower patch antenna includes a first feeding point and a second feeding point. The upper patch antenna and the lower patch antenna have circular shapes. A surface of the upper patch antenna is smaller than a surface of the lower patch antenna. The lower patch antenna is disposed between the upper patch antenna and the grounding layer. The grounding layer is disposed between the lower patch antenna and the transmission line layer. The first feeding line passes through the grounding layer and coupled between the transmission line layer and the first feeding point of the lower patch antenna. The second feeding line passes through the grounding layer and coupled between the transmission line layer and the second feeding point of the lower patch antenna. The first feeding line and the second feeding line are orthogonal to each other. Each of the first feeding line and the second feeding line includes a first portion, a second portion, and a third portion. The first portion is disposed between the lower patch antenna and the grounding layer and perpendicular to the grounding layer. The second portion is disposed between the grounding layer and the transmission line layer and perpendicular to the grounding layer. The third portion is disposed within the grounding layer and parallel to the grounding layer. The third portion is coupled between the first portion and the second portion.

The present disclosure further provides a low earth orbit satellite system utilizes above discussed antenna structure, a bandpass filter, an up-down frequency converter, and a digital signal processor.

### BRIEF DESCRIPTION OF THE DRAWINGS

The disclosure can be fully understood by following detailed description of the embodiment, with reference made to the accompanying drawings:

FIG. 1 is a system block diagram of a low earth orbit satellite system in accordance with one embodiment of the present disclosure.

FIG. 2 is a cross-sectional view of an antenna structure according to one embodiment of the present disclosure.

FIG. 3 is a cross-sectional view of the antenna structure according to one embodiment of the present disclosure.

FIG. 4 is a top perspective view of the antenna structure according to one embodiment of the present disclosure.

FIG. 5 is a top perspective view of the antenna structure according to another embodiment of the present disclosure.

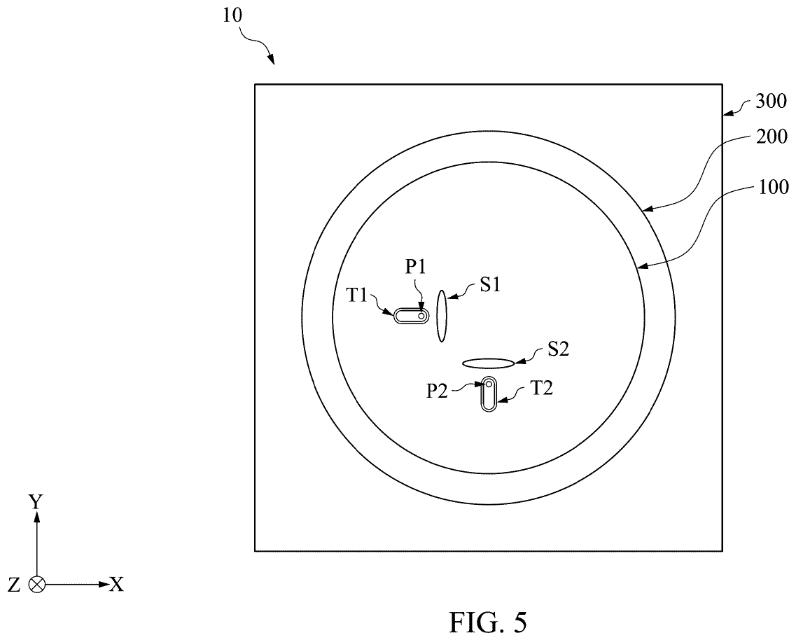

FIG. 6 is an S-parameter graph of the antenna structure according to one embodiment of the present disclosure.

FIG. 7 is a structural diagram of a bandpass filter according to embodiments of the present disclosure.

FIG. 8 is an S-parameter graph of the bandpass filter according to one embodiment of the present disclosure.

FIG. 9 is an S-parameter graph of the low earth orbit satellite system according to one embodiment of the present disclosure.

### DETAILED DESCRIPTION

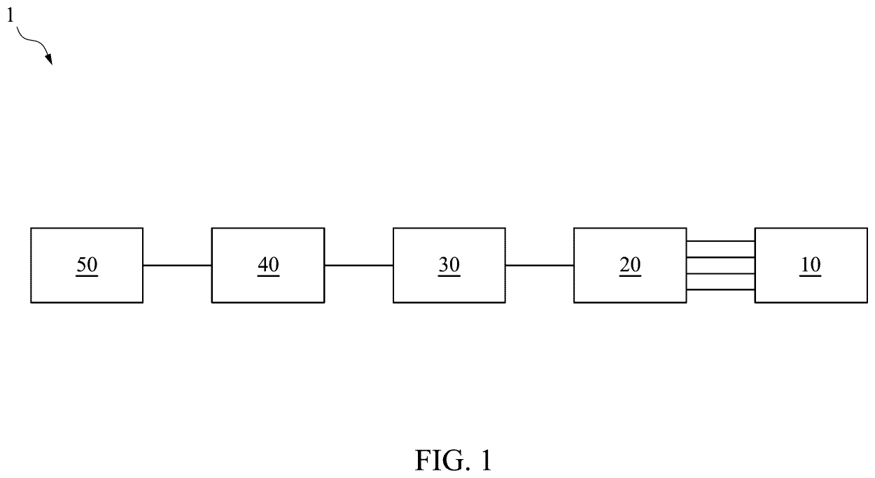

FIG. 1 is a system block diagram of a low earth orbit (LEO) satellite system 1 in accordance with one embodiment of the present disclosure. The LEO satellite system 1 includes an antenna structure 10, a beamforming chip 20, a bandpass filter 30, an up-down frequency converter 40, and a digital signal processor 50.

The LEO satellite system 1 is a beam sweeping system applied to LEO satellite. The low-orbit satellite system 1 may track and directionally transmit and receive satellite signals through the “beamforming” function of the beamforming chip 20, thereby overcoming the shortfall of signal interference with fixed directional transmission. In addition, the antenna structure 10 is operated in a higher frequency band (e.g., Ka band), which helps receive weak signals in remote areas.

When the LEO satellite system 1 is in a receiving mode, the beamforming chip 20 is coupled to the antenna structure 10 to perform beamforming on a first radio frequency (RF) signal (i.e. radiation pattern of the antenna structure 10 is formed as a beam), so that the antenna structure 10 receives the first RF signal. The bandpass filter 30 is coupled to the beamforming chip 20 to perform bandpass filtering on the first RF signal. The up-down frequency converter 40 is coupled to the bandpass filter 30 to down-convert the first RF signal to a first baseband signal. The digital signal processor 50 is coupled to the up-down frequency converter 40 to process digital signal on the first baseband signal.

When the LEO satellite system 1 is in a transmission mode, the digital signal processor 50 further generates a second baseband signal, and the up-down frequency converter 40 further up-converts the second baseband signal into a second RF signal. The beamforming chip 20 forms the radiation pattern of the antenna structure 10 in a beam, and then the antenna structure 10 transmits the second RF signal in a specific direction.

In another embodiment of the present disclosure, the LEO satellite system 1 includes the bandpass filter 30 as well as a mixer and/or a low-noise amplifier to process the first RF signal when the LEO satellite system 1 is in the receiving mode. In yet another embodiment of the present disclosure, the LEO satellite system 1 includes the bandpass filter 30 as well as a mixer and/or a power amplifier to process the second RF signal when the LEO satellite system 1 is in the transmission mode.

The digital signal processor 50 may generate the second baseband signal by processing the information containing signal to be transmitted and may generate the information containing signal by processing the received first baseband signal. For example, the digital signal processor 50 may include an encoder, a modulator, and a digital-to-analog converter (DAC) for generating the second baseband signal. In addition, the digital signal processor 50 may include an analog-to-digital converter (ADC), a demodulator and a decoder to process the received first baseband signal. The transmission mode or the receiving mode may be set by the digital signal processor 50. In some embodiments, digital signal processor 50 may include one or more cores and a memory that stores instructions executed by the cores, and at least a portion of the digital signal processor 50 may include a software block stored in the memory.

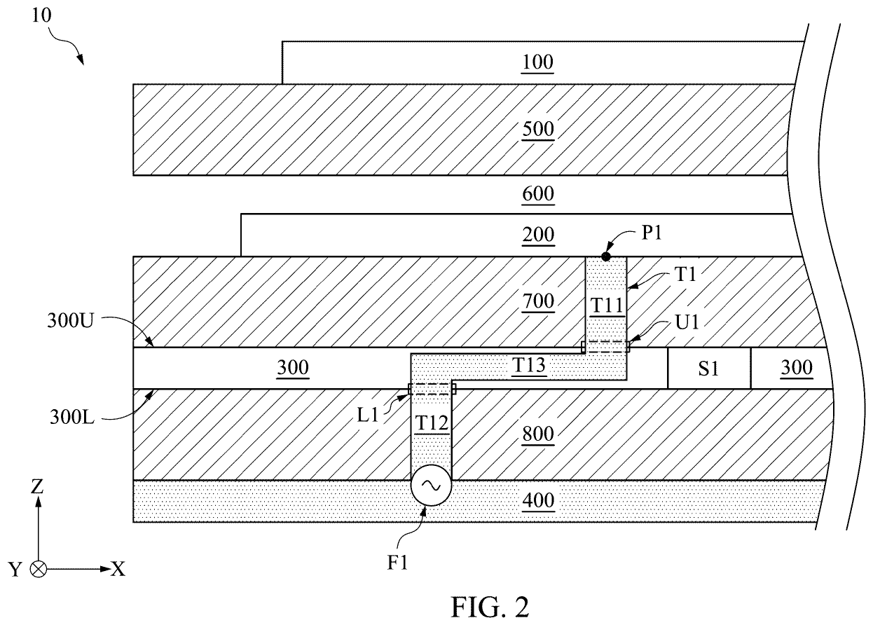

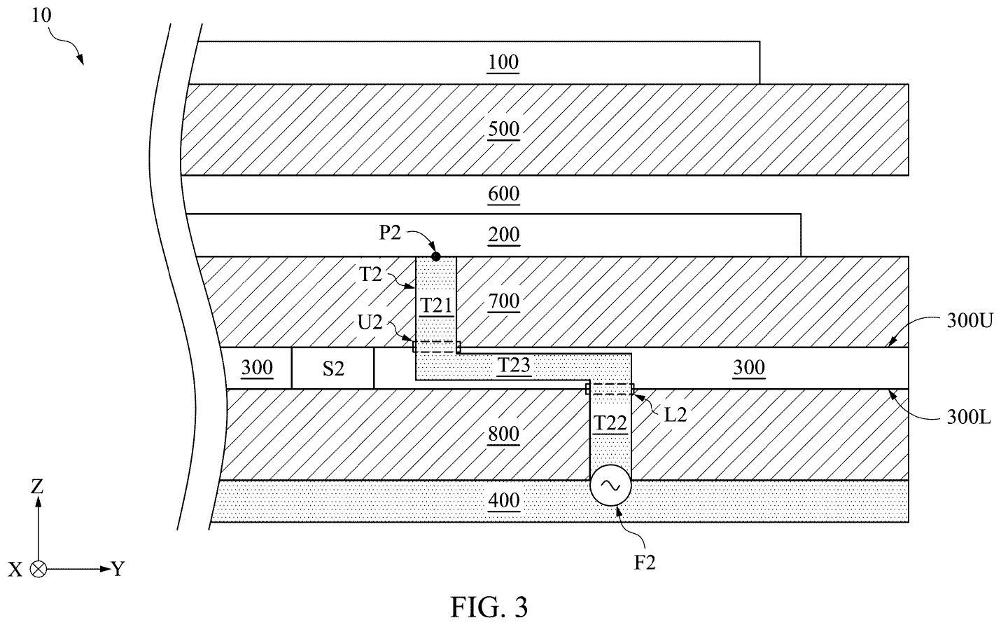

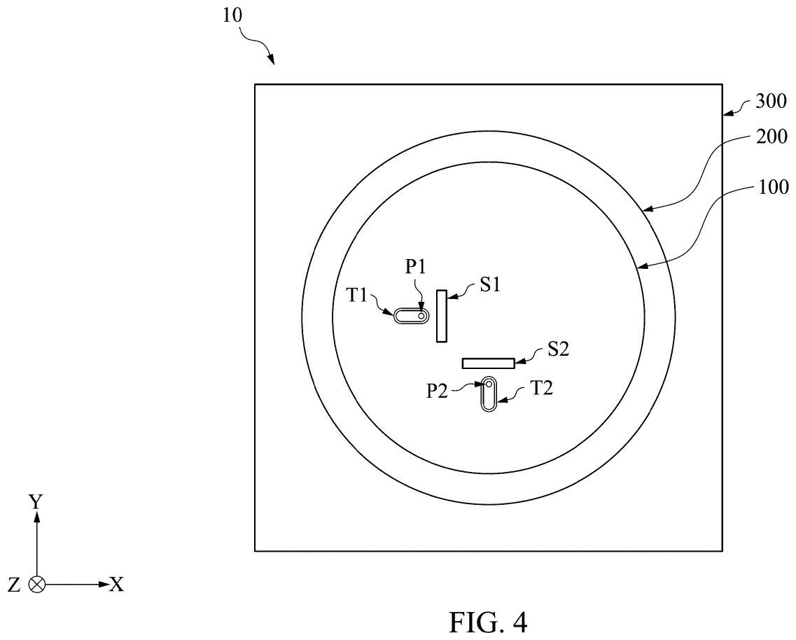

Referring to FIG. 2, FIG. 3, and FIG. 4, the antenna structure 10 includes an upper patch antenna 100, a lower patch antenna 200, a grounding layer 300, a transmission line layer 400, a first feeding line T1 and a second feeding line T2. As shown in FIG. 2 and FIG. 3, the lower patch antenna 200 is disposed between the upper patch antenna 100 and the grounding layer 300, and the grounding layer 300 is disposed between the lower patch antenna 200 and the transmission line layer 400. Each of the upper patch antenna 100, the lower patch antenna 200, and the grounding layer 300 may be made of a metal plate or a metal piece.

As shown in FIG. 2 and FIG. 3, the lower patch antenna 200 includes a first feeding point P1 and a second feeding point P2. As shown in FIG. 2, the first feeding line T1 passes through the grounding layer 300, and the first feeding line T1 is coupled between the transmission line layer 400 and the first feeding point P1 of the lower patch antenna 200. As shown in FIG. 3, the second feeding line T2 passes through the grounding layer 300 to be coupled between the transmission line layer 400 and the second feeding point P2 of the lower patch antenna 200.

As shown in FIG. 2, the first feeding line T1 includes a first portion T11, a second portion T12, and a third portion T13. The third portion T13 is coupled between the first portion T11 and the second portion T12. The first portion T11 is disposed between the lower patch antenna 200 and the grounding layer 300 and perpendicular to the grounding layer 300. The second portion T12 is disposed between the grounding layer 300 and the transmission line layer 400 and perpendicular to the grounding layer 300. The third portion T13 is disposed within the grounding layer 300 and parallel to the grounding layer 300.

As shown in FIG. 3, the second feeding line T2 includes a first portion T21, a second portion T22, and a third portion T23. The third portion T23 is coupled between the first portion T21 and the second portion T22. The first portion T21 is disposed between the lower patch antenna 200 and the grounding layer 300 and perpendicular to the grounding layer 300. The second portion T22 is disposed between the grounding layer 300 and the transmission line layer 400 and perpendicular to the grounding layer 300. The third portion T23 is disposed within the grounding layer 300 and parallel to the grounding layer 300.

As shown in FIG. 4, each of the upper patch antenna 100 and the lower patch antenna 200 has a circular shape, and the surface of the upper patch antenna 100 is smaller than the surface of the lower patch antenna 200. When the upper patch antenna 100 has a first vertical projection and the lower patch antenna 200 has a second vertical projection on the grounding layer 300, the two projections are concentric but the first vertical projection is completely inside the second vertical projection.

The upper patch antenna 100 and the lower patch antenna 200 are stacked to each other to form a double-layer circular patch antenna. The upper patch antenna 100 is completely separated from the lower patch antenna 200 and in a floating state. The upper patch antenna 100 may receive part of the electromagnetic waves radiated by the lower patch antenna 200, so that the upper patch antenna 100 is excited to radiate electromagnetic waves in a similar frequency band, thereby improving the gain and the bandwidth of the antenna structure 10.

The lower patch antenna 200 includes a first feeding point P1 and a second feeding point P2 to radiate an electromagnetic wave signal. The electromagnetic wave signal is supplied to the first feeding point P1 and the second feeding point P2 through the first feeding line T1 and the second feeding line T2 respectively. The upper patch antenna 100 is coupled with the lower patch antenna 200.

The antenna structure 10 further includes a first substrate 500, an air layer 600, a second substrate 700, and a third substrate 800. The first substrate 500 is disposed between the upper patch antenna 100 and the lower patch antenna 200. The air layer 600 is disposed between the first substrate 500 and the lower patch antenna 200. The second substrate 700 is disposed between the lower patch antenna 200 and the grounding layer 300. The third substrate 800 is disposed between the grounding layer 300 and the transmission line layer 400. The thickness of the air layer 600 may be adjusted for reducing the dielectric constant of the first substrate 500 to reduce the Q value of the antenna structure 10, thereby increasing the bandwidth and the gain of the antenna structure 10.

Each of the first substrate 500, the second substrate 700, and the third substrate 800 includes a liquid crystal polymer (LCP) material. The LCP material has good anti-hygroscopicity, so that the antenna structure 10 has good environmental tolerance and is not easily affected by the environment (such as high humidity caused by rain). The antenna structure 10 is convenient for use as a vehicle antenna, and is suitable for being placed on the roof of the vehicle for use in remote areas where tower signals often do not cover. The LCP also allows bending to some extends.

The grounding layer 300 has an upper surface 300U close to the lower patch antenna 200 and a lower surface 300L away from the lower patch antenna 200. The grounding layer 300 includes a first upper opening U1 and a second upper opening U2 disposed on the upper surface 300U, and the grounding layer 300 further includes a first lower opening L1 and the second lower opening L2 disposed on the lower surface 300L. The first portion T11 of the first feeding line T1 is coupled to the third portion T13 of the first feeding line T1 through the first upper opening U1. The first portion T21 of the second feeding line T2 is coupled to the third portion T23 of the second feeding line T2 through the second upper opening U2. The second portion T12 of the first feeding line T1 is coupled to the third portion T13 of the first feeding line T1 through the first lower opening L1. The second portion T22 of the second feeding line T2 is coupled to the third portion T23 of the second feeding line T2 through the second lower opening L2.

The vertical projections of the first upper opening U1 and the first lower opening L1 on the grounding layer 300 do not overlap each other. The first upper opening U1 and the first lower opening L1 are staggered instead of stacked for enhancing the isolation of the antenna structure 10.

Similarly, the second upper opening U2 and the second lower opening L2 on the grounding layer 300 are staggered instead of stacked for enhancing the isolation of the antenna structure 10.

The transmission line layer 400 is a 50-ohm. The first feeding line T1 and the second feeding line T2 respectively receive the first feeding signal F1 and the second feeding signal F2 from the transmission line layer 400. The first feeding signal F1 is orthogonal to the second feeding signal F2. The extending direction of the third portion T13 of the first feeding line T1 (e.g., the X direction in FIG. 2) is orthogonal to the extending direction of the third portion T23 of the second feeding line T2 (e.g., the Y direction in FIG. 3).

The first feeding line T1 may be a first coaxial cable. The central conductive line of the first coaxial cable is coupled to the first feeding point P1. The conductive housing of the first coaxial cable is coupled to the grounding layer 300 but does not directly contact the lower patch antenna 200. The second feeding line T2 may be a second coaxial cable line. The center conductor line of the second coaxial cable is coupled to the second feeding point P2. The conductor housing of the second coaxial cable is coupled to the grounding layer 300 but does not directly contact the lower patch antenna 200. The transmission line layer 400 generates a feed-in signal and an electromagnetic wave signal (i.e., the first feeding signal F1 and the second feeding signal F2) with the same operating frequency, and the feed-in signal and the electromagnetic wave signal are respectively provided to the first feeding line T1 and the seconding feeding line T2, thereby exciting the antenna structure 10 to have dual polarization characteristics.

The first feeding line T1 provides the first polarization direction and the second feeding line T2 provides the second polarization direction. The first feeding line T1 and the second feeding line T2 are utilized at the same time for forming a dual-coupling-fed and dual-polarized patch antenna structure. It is noted that one effective feeding capacitor is generated between the first feeding point P1 and the lower patch antenna 200, and the other effective feeding capacitor is generated between the second feeding point P2 and the lower patch antenna 200, and thus the bandwidth of the antenna structure 10 can be significantly increased. Furthermore, this dual-coupling-fed mechanism may further improve cross-polarization isolation (XPI) of the antenna structure 10.

The grounding layer 300 further includes a first slot S1 and a second slot S2 penetrating the grounding layer 300. The first slot S1 is adjacent to the first upper opening U1 located between the first slot S1 and the first lower openings L1. The second slot S2 is adjacent to the second upper opening U2 located between the second slot S2 and the second lower opening L2. The first slot S1 and the second slot S2 achieve an isolation degree up to −20 dB.

Each of the first slot S1 and the second slot S2 has a rectangular shape in the top view (e.g., the Z direction in FIG. 4). The long side of the first slot S1 is orthogonal to the third portion T13 of the first feeding line T1. The long side of the second slot S2 is orthogonal to the third portion T23 of the feeding line T2. The shape of the first slot S1 and the second slot S2 may also be elliptical in other embodiments of the present disclosure.

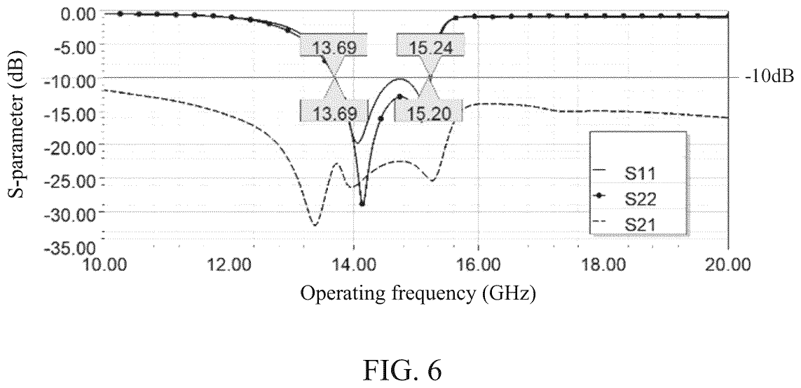

FIG. 6 is an S-parameter graph of the antenna structure 10 according to one embodiment of the present disclosure. The horizontal axis represents the operating frequency (in GHZ), and the vertical axis represents S-parameter (in dB). According to the S11 parameter and the S22 parameter in FIG. 6, when the first feeding signal F1 and the second feeding signal F2 are fed into the antenna structure 10 at the same time, the operating frequency band of the antenna structure 10 below −10 dB (the frequency band which meets the impedance matching) may cover between 13.69 GHZ and 15.24 GHZ. Therefore, the antenna structure 10 is suitable for wide-band operations in the LEO satellite system 1. In addition, according to the S21 parameter in FIG. 6, at frequency between 13.75 GHz and 14.50 GHz, the isolation degree between the first feeding signal F1 and the second feeding signal F2 may be lower than −20 dB, which can meet the actual application requirements of the LEO satellite system 1. In addition, according to the measurement results, when the antenna structure 10 is operated at 14 GHZ, the measured gain of the antenna structure 10 exceeds 7 dBi (the measured value is 7.2 dBi).

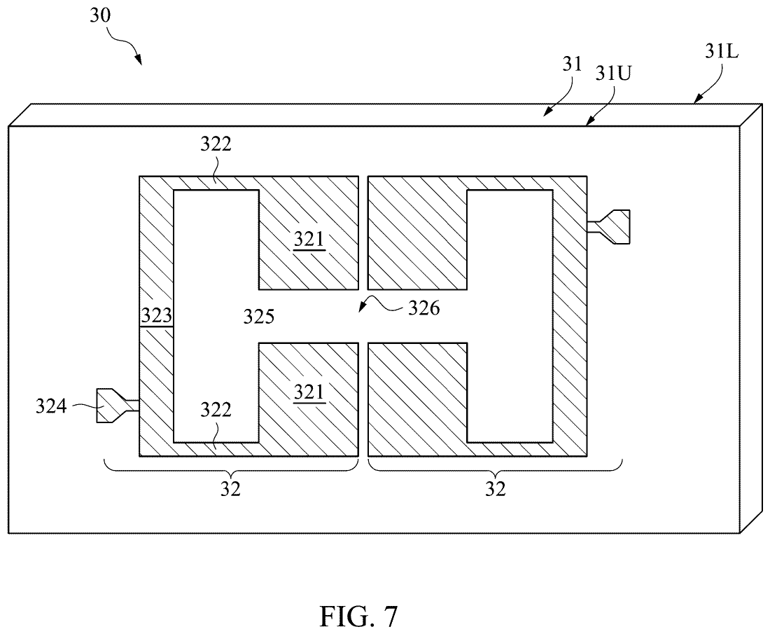

FIG. 7 is a structural diagram of the bandpass filter 30 according to embodiments of the present disclosure. The bandpass filter 30 includes a substrate 31 and two stepped impedance resonators 32 symmetrically arranged on an upper surface 31U of the substrate 31. Each of the stepped impedance resonators 32 is an open loop ring resonator (OLR). Specifically, two stepped impedance resonators 32 are spaced apart on the upper surface 31U of the substrate 31, and two stepped impedance resonators 32 are symmetrical. The stepped impedance resonators 32 are made of metal micro-strip lines.

Each of the stepped impedance resonators 32 is a stepped impedance resonator including two first impedance segments 321, two second impedance segments 322, a third impedance segment 323, and an input/output terminal 324 connected to the third impedance segment 323. The third impedance segment 323 is connected between the two second impedance segments 322. One of the first impedance segments 321 is connected to one of the second impedance segments 322, and another one of the first impedance segments 321 is connected to another of the second impedance segments 322. The first impedance segments 321 are adjacent to each other but not in contact with each other.

In some embodiments, the signal to be filtered is input from the input/output terminal 324 of one of the stepped impedance resonators 32, and the filtered signal is output from the input/output terminal 324 of another one of the stepped impedance resonators 32.

In some embodiments, each of the first impedance segments 321, the second impedance segments 322, and the third impedance segment 323 has a rectangular shape. The impedance of each of the first impedance segments 321 is less than the impedance of each of the second impedance segments 322. The impedance of the third impedance segment 323 is less than the impedance of each of the second impedance segments 322. The line width of each of the first impedance segments 321 is greater than the line width of each of the second impedance segments 322. The line width of the third impedance segment 323 is greater than the line width of each of the second impedance segments 322.

A conventional stepped impedance resonator is formed by a high impedance segment with two low impedance segments, and its line widths are configured as “fat, thin, fat” (the terms fat and thin are used to describe different line widths). The resonant frequency of a conventional stepped impedance resonator is altered by adjusting the impedance ratio and the electrical length ratio. In contrast, each of the stepped impedance resonators 32 of the bandpass filter 30 comprises split first impedance segments 321 and second impedance segments 322. Together with the third impedance segment 323, the line widths structure becomes “fat, thin, fat, thin, fat”. Compared to conventional “fat, thin, fat” structure, the size of the stepped impedance resonators 32 of the present disclosure is reduced by 40%. In addition, the impedance matching is also better than that of the conventional stepped impedance resonator.

In another embodiment, characteristics of the bandpass filter 30 may be altered by adjusting the ratio of the line widths of the first impedance segments 321, the second impedance segments 322, and the third impedance segment 323 as shown in FIG. 7. However, each stepped impedance resonators 32 still needs to maintain a design structure with the line widths of “fat, thin, fat, thin, fat”.

The ideal impedance of the input/output terminal 324 is 50 ohms to achieve good impedance matching in this embodiment. The input/output terminal 324 is a fan-shaped tapered line to feed signal, so that the impedance discontinuity from 50 ohm to 30 ohm in the bandpass to improve the signal flatness.

The input/output terminal 324 is fan-shaped that the width is gradually increased in the direction away from the third impedance segment 323. Such design suppresses high-frequency stopband (triple frequency)/noise. The input/output terminal 324 adopt a zero-degree feeding to generate a transmission zero point.

Each of the stepped impedance resonators 32 has a hollow region 325 inside with the opening 326. The two stepped impedance resonators 32 are open loop resonators, hence the opening 326 of one of the stepped impedance resonators 32 faces the opening 326 of another stepped impedance resonators 32.

The first impedance segments 321, second impedance segments 322, and third impedance segment 323 of each stepped impedance resonators 32 form a C-shaped coupling structure. The hollow region 325 of each stepped impedance resonators 32 is T-shaped to enhance the coupling effect at the tail of the two C-shaped coupling structures.

The bandpass filter 30 further includes a metal grounding board disposed on a lower surface 31L of the substrate 31. The metal grounding board provides the bandpass filter 30 transmission zeros, thereby improving the out-of-passband suppression capability and pass-band performance of the bandpass filter 30.

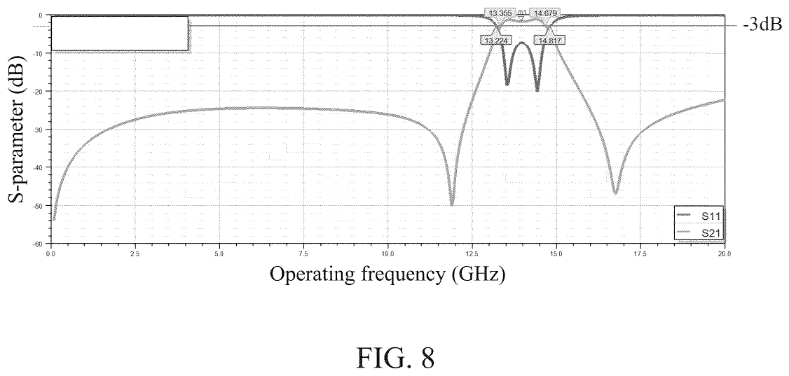

FIG. 8 is an S-parameter graph of the bandpass filter 30 according to one embodiment of the present disclosure. The operating frequency band of the bandpass filter 30 may cover between 13.35 GHz and 14.67 GHz and is suitable for wide-band operations. In addition, the insertion loss is −1.79 dB which meet the requirements of the LEO satellite system.

Referring to FIG. 1, the substrate of each of the beamforming chip 20, the up-down frequency converter 40, and the digital signal processor 50 includes LCP material and is thus bendable. LCP material has good anti-hygroscopicity and good environmental tolerance. The LEO satellite system 1 is suitable to be placed on the roof of the vehicle and used in remote areas in all weather conditions.

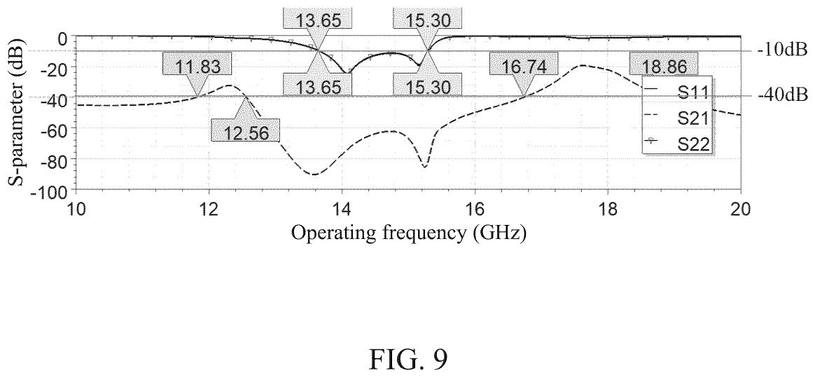

FIG. 9 is an S-parameter graph of the LEO satellite system 1 according to one embodiment of the present disclosure, the operating frequency band may cover between 13.65 GHz and 15.30 GHz and therefore suitable for wide-band operations in the LEO satellite. In addition, the isolation degree may be lower than −40 dB sufficient to meet the requirements of the LEO satellite system 1.

To sum up, the present disclosure provides a LEO satellite system consists of an antenna structure, a beamforming chip, a bandpass filter, an up-down frequency converter, and a digital signal processor. The substrates of these components all include an LCP material. The hygroscopicity of the LCP material is low and thus good environmental tolerance. The antenna structure adopts a design of a double-layer circular patch antenna to achieve a dual-coupling-fed and dual-polarized patch antenna structure. The openings on the upper surface and the lower surface of the grounding layer are staggered to improve impedance matching. The grounding layer of the antenna structure further provides slots near the openings on its upper surface to achieve an isolation degree up to −20 dB. The stepped impedance resonators of the bandpass filter uses a “fat, thin, fat, thin, fat” line width design to reduce overall size and to better impedance matching.

What is claimed is:

1. An antenna structure, comprising:
an upper patch antenna;
a lower patch antenna comprising a first feeding point and a second feeding point, wherein the upper patch antenna and the lower patch antenna have circular shapes, wherein a surface of the upper patch antenna is smaller than a surface of the lower patch antenna;
a grounding layer, wherein the lower patch antenna is disposed between the upper patch antenna and the grounding layer;
a transmission line layer, wherein the grounding layer is disposed between the lower patch antenna and the transmission line layer;
a first feeding line passing through the grounding layer and coupled between the transmission line layer and the first feeding point of the lower patch antenna; and
a second feeding line passing through the grounding layer and coupled between the transmission line layer and the second feeding point of the lower patch antenna;
wherein the first feeding line and the second feeding line are orthogonal to each other and each of the first feeding line and the second feeding line comprises:
a first portion disposed between the lower patch antenna and the grounding layer and perpendicular to the grounding layer;
a second portion disposed between the grounding layer and the transmission line layer and perpendicular to the grounding layer; and
a third portion disposed within and parallel to the grounding layer, wherein the third portion is coupled between the first portion and the second portion.

2. The antenna structure of claim 1, further comprising:
a first substrate disposed between the upper patch antenna and the lower patch antenna;
an air layer disposed between the first substrate and the lower patch antenna;
a second substrate disposed between the lower patch antenna and the grounding layer; and
a third substrate disposed between the grounding layer and the transmission line layer;
wherein each of the first substrate, the second substrate, and the third substrate includes a liquid crystal polymer (LCP) material.

3. The antenna structure of claim 1, wherein the grounding layer has an upper surface close to the lower patch antenna and a lower surface away from the lower patch antenna; the grounding layer comprises a first upper opening and a second upper opening disposed on the upper surface and a first lower opening and a second lower opening disposed on the lower surface; the first portion of the first feeding line is coupled to the third portion of the first feeding line through the first upper opening, the first portion of the second feeding line is coupled to the third portion of the second feeding line through the second upper opening, the second portion of the first feeding line is coupled to the third portion of the first feeding line through the first lower opening, the second portion of the second feeding line is coupled to the third portion of the second feeding line through the second lower opening; wherein vertical projections of the first upper opening and the first lower opening on the grounding layer do not overlap each other, and vertical projections of the second upper opening and the second lower opening on the grounding layer do not overlap each other.

4. The antenna structure of claim 1, wherein the first feeding line and the second feeding line respectively receive a first feeding signal and a second feeding signal, wherein an extending direction of the third portion of the first feeding line is orthogonal to an extending direction of the third portion of the second feeding line.

5. The antenna structure of claim 3, wherein the grounding layer further comprises a first slot and a second slot penetrating the grounding layer, wherein the first slot is adjacent to the first upper opening located between the first slot and the first lower opening, and the second slot is adjacent to the second upper opening located between the second slot and the second lower opening.

6. The antenna structure of claim 5, wherein each of the first slot and the second slot has a rectangular shape or an elliptical shape, and a long side of the first slot is orthogonal to the third portion of the first feeding line, and a long side of the second slot is orthogonal to the third portion of the second feeding line.

7. A low earth orbit satellite system, comprising:
an antenna structure configured to receive a first radio frequency signal and a second radio frequency signal;
a beamforming chip coupled to the antenna structure to perform beamforming on the first radio frequency signal;
a bandpass filter coupled to the beamforming chip to perform bandpass filtering on the first radio frequency signal;
an up-down frequency converter coupled to the bandpass filter to down-convert the first radio frequency signal to a first baseband signal and to up-convert a second baseband signal to the second radio frequency signal; and
a digital signal processor coupled to the up-down frequency converter to process the first baseband signal and to generate the second baseband signal;
wherein the antenna structure comprises:
an upper patch antenna;
a lower patch antenna comprising a first feeding point and a second feeding point, the upper patch antenna and the lower patch antenna have circular shapes, a surface of the upper patch antenna is smaller than a surface of the lower patch antenna;
a grounding layer, wherein the lower patch antenna is disposed between the upper patch antenna and the grounding layer;
a transmission line layer, wherein the grounding layer is disposed between the lower patch antenna and the transmission line layer;
a first feeding line passing through the grounding layer and coupled between the transmission line layer and the first feeding point of the lower patch antenna; and
a second feeding line passing through the grounding layer and coupled between the transmission line layer and the second feeding point of the lower patch antenna;
wherein the first feeding line and the second feeding line are orthogonal to each other, and each of the first feeding line and the second feeding line comprises:
a first portion disposed between the lower patch antenna and the grounding layer and perpendicular to the grounding layer;
a second portion disposed between the grounding layer and the transmission line layer and perpendicular to the grounding layer; and
a third portion disposed within the grounding layer and parallel to grounding layer, wherein the third portion is coupled between the first portion and the second portion.

8. The low earth orbit satellite system of claim 7, wherein the bandpass filter comprises a substrate, two stepped impedance resonators symmetrically arranged on an upper surface of the substrate, and a metal grounding board arranged on a lower surface of the substrate, wherein each of the two stepped impedance resonators is an open loop ring resonator, wherein the substrate of the bandpass filter includes an LCP material, wherein a substrate of each of the beamforming chip, the up-down frequency converter, and the digital signal processor includes the LCP material.

9. The low earth orbit satellite system of claim 8, wherein each of the two stepped impedance resonators includes two first impedance segments, two second impedance segments, a third impedance segment, and an input/output terminal connected to the third impedance segment; wherein the third impedance segment is connected between the second impedance segments, two first impedance segments are respectively connected to two second impedance segments; and two first segments of one stepped impedance resonator are adjacent to but not in contact with two first segments of another stepped impedance resonator.

10. The low earth orbit satellite system of claim 9, wherein an impedance of each of the first impedance segments is less than an impedance of each of the second impedance segments, and an impedance of the third impedance segment is less than the impedance of each of the second impedance segments; a line width of each of the first impedance segments is greater than a line width of each of the second impedance segments, and a line width of the third impedance segment is greater than the line width of each of the second impedance segments.

11. The low earth orbit satellite system of claim 9, wherein the first impedance segments, the second impedance segments and the third impedance segment of each of the two stepped impedance resonators form a C-shaped coupling structure, wherein a characteristic impedance of the input/output terminal is 50 ohms, and the input/output terminal is fan-shaped tapered line.

12. The low earth orbit satellite system of claim 7, wherein the antenna structure further comprises:
a first substrate disposed between the upper patch antenna and the lower patch antenna;
an air layer disposed between the first substrate and the lower patch antenna;
a second substrate disposed between the lower patch antenna and the grounding layer; and
a third substrate disposed between the grounding layer and the transmission line layer;
wherein each of the first substrate, the second substrate, and the third substrate includes an LCP material.

13. The low earth orbit satellite system of claim 7, wherein the grounding layer has an upper surface close to the lower patch antenna and a lower surface away from the lower patch antenna, wherein the grounding layer comprises a first upper opening and a second upper opening disposed on the upper surface, and a first lower opening and a second lower opening disposed on the lower surface, the first portion of the first feeding line is coupled to the third portion of the first feeding line through the first upper opening, the first portion of the second feeding line is coupled to the third portion of the second feeding line through the second upper opening, the second portion of the first feeding line is coupled to the third portion of the first feeding line through the first lower opening, the second portion of the second feeding line is coupled to the third portion of the second feeding line through the second lower opening; and vertical projections of the first upper opening and the first lower opening on the grounding layer do not overlap each other, and vertical projections of the second upper opening and the second lower opening on the grounding layer do not overlap each other.

14. The low earth orbit satellite system of claim 7, wherein the first feeding line and the second feeding line respectively receive a first feeding signal and a second feeding signal, an extending direction of the third portion of the first feeding line is orthogonal to an extending direction of the third portion of the second feeding line.

15. The low earth orbit satellite system of claim 13, wherein the grounding layer further comprises a first slot and a second slot penetrating the grounding layer, wherein the first slot is adjacent to the first upper opening located between the first slot and the first lower opening, and the second slot is adjacent to the second upper opening located between the second slot and the second lower opening.

16. The low earth orbit satellite system of claim 15, wherein each of the first slot and the second slot has a rectangular shape or an elliptical shape, and the first slot is orthogonal to the third portion of the first feeding line, and the second slot is orthogonal to the third portion of the second feeding line.
